(19) United States
(12) Patent Application Publication
(10) Pub. No.: US 2006/0220412 A1
(43) Pub. Date: Oct. 5, 2006

(54) Vehicle sliding door interlock mechanism

(75) Inventor: Thomas Norton, Livonia, MI (US)

Correspondence Address: GLOBAL IP COUNSELORS, LLP, 1233 20TH STREET, NW, SUITE 700, WASHINGTON, DC, 20036-2680, US

(73) Assignee: Nissan Technical Center North America, Inc., Farmington Hills, MI (US)

(21) Appl. No.: 11/094,418

(22) Filed: Mar. 31, 2005

(51) Int. Cl. B60J 3/00

(52) U.S. Cl. 296/97.2

(57) ABSTRACT

A vehicle sliding door interlock mechanism is provided to lock a sliding door of a vehicle when a fuel filler door is in the opened position. The sliding door interlock mechanism basically has a sliding door locking device, a fuel filler door opening device and a linkage arrangement operatively coupling the sliding door locking device to the fuel filler door opening device. The fuel filler opening device preferably includes a plunger that is selectively movable between a lockable retracted position and an extended position in which the plunger applies an opening force to the fuel filling door. When the plunger moves from the retracted position to the extended position, the linkage arrangement is operates the sliding door locking device to lock the sliding door of the vehicle.

### BACKGROUND OF THE INVENTION

1. Field of the Invention

The present invention generally relates to an interlock mechanism for a vehicle sliding door. More specifically, the present invention relates to an interlock mechanism that locks a vehicle sliding door when the fuel filler door is open.

2. Background Information

Recently, vans have become very popular vehicles for transporting people and/or cargo. In the past, most vans only had a sliding rear door on one of the sides of the vehicle. In a vehicle with a single sliding rear door, the fuel filler pipe could be positioned on the side of the vehicle opposite to the sliding door to avoid the sliding door hitting the fuel filler door when the fuel filler door is open. Thus, the position of the fuel filler pipe can be easily accommodated in designing the vehicle.

However, more recently, many vans have been provided with rear sliding doors on both sides of the vehicle. This arrangement of two rear sliding doors has presented a problem regarding the positioning of the fuel filler pipe. In such type of vehicles with two sliding rear doors, the location of the fuel filler pipe should be located in the area to avoid interference with the sliding rear door in the event that the fuel filler door is open for fueling and the sliding door is subsequently opened. This problem significantly limited the design of the vehicle. To avoid such design limitations in a vehicle with two sliding doors, vehicle sliding door interlock mechanisms have been developed that lock the rear sliding door when the fuel filler door is open. Thus, accidentally hitting the fuel filler door with the rear sliding door is prevented with the use of a vehicle sliding door interlock mechanism.

Some examples of such interlock mechanisms are disclosed in the following publications: U.S. Pat. No. 4,620,744 to Yui et al.; U.S. Pat. No. 5,520,431 to Kapes et al.; U.S. Pat. No. 5,454,618 to Sullivan; U.S. Pat. No. 5,538,312 to Lehmkuhl; U.S. Pat. No. 5,676,416 to Cooper; U.S. Pat. No. 5,769,481 to Cooper; U.S. Pat. No. 5,906,405 to Cooper; U.S. Pat. No. 6,007,141 to Thomas et al.; and U.S. Pat. No. 6,199,938 to Choi. These interlock mechanisms work well. However, using such interlock mechanisms increase the overall cost of the vehicle. Thus, it is desirable to minimize the costs involved with using an interlock mechanism.

In view of the above, it will be apparent to those skilled in the art from this disclosure that there exists a need for-an improved vehicle sliding interlock mechanism. This invention addresses this need in the art as well as other needs, which will become apparent to those skilled in the art from this disclosure.

### SUMMARY OF THE INVENTION

One object of the present invention is to provide a vehicle sliding interlock mechanism that is relatively inexpensive to manufacture.

Another object of the present invention is to provide a vehicle sliding interlock mechanism that can be easily installed.

Another object of the present invention is to provide a vehicle sliding interlock mechanism that uses parts of a door opening mechanism to reduce the total number of parts needed for the vehicle sliding interlock mechanism.

In order to achieve the above object and other objects of the present invention, a vehicle sliding interlock mechanism is provided that basically comprises a sliding door locking device, a fuel filler door opening device and a linkage arrangement. The sliding door locking device is configured to selectively lock a sliding door of a vehicle. The fuel filler door opening device has a plunger that is selectively movable between a lockable retracted position and an extended position in which the plunger is configured to selectively apply an opening force to a fuel filler door when the plunger moves from the lockable retracted position to the extended position. The linkage arrangement is operatively coupled between the sliding door locking device and the plunger of the fuel filler door opening device to selectively operate the sliding door locking device to lock the sliding door of the vehicle in response to the plunger moving from the lockable retracted position to the extended position.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a side elevational view of a vehicle (mini-van) having a vehicle sliding interlock mechanism in accordance with one embodiment of the present invention;

FIG. 2 is a side elevational view of the vehicle illustrated in FIG. 1 with the driver side sliding door open;

FIG. 3 is a partial side elevational view of the vehicle illustrated in FIGS. 1 and 2 with the outer body panel of the vehicle removed to expose portions of the vehicle sliding interlock mechanism in accordance with the present invention;

FIG. 4 is an enlarged, partial perspective view showing the position of the fuel filler door opening device of the vehicle sliding door interlock mechanism relative to the fuel filler pipe;

FIG. 5 is a diagrammatic perspective view of the vehicle sliding interlock mechanism showing the fuel filler door opening device connected to the sliding door locking device via the linkage arrangement with the vehicle sliding door in the closed position, the fuel filler door opening device in the retracted position and the sliding door locking device in the unlocked position;

FIG. 6 is a diagrammatic perspective view of the vehicle sliding interlock mechanism showing the fuel filler door opening device connected to the sliding door locking device via the linkage arrangement with the vehicle sliding door in the opened position, the fuel filler door opening device in the retracted position and the sliding door locking device in unlocked position;

FIG. 7 is a diagrammatic perspective view of the vehicle sliding interlock mechanism showing the fuel filler door opening device connected to the sliding door locking device via the linkage arrangement with the vehicle sliding door in the closed position, the fuel filler door opening device in the extended position such that the fuel filler door is opened and the sliding door locking device is in the locked position to prevent the sliding door from opening;

FIG. 8 is a side elevational view of the sliding door locking device of the vehicle sliding interlock mechanism in accordance with the present invention;

FIG. 9 is a bottom plan view of the sliding door locking device of the vehicle sliding interlock mechanism in accordance with the present invention;

FIG. 10 is a bottom plan view of the sliding door locking device in the locked position with the vehicle sliding door shown in phantom lines;

FIG. 11 is a bottom perspective view of the fuel filler door opening device in the lockable retracted position in accordance with the present invention;

FIG. 12 is another bottom side perspective view of the fuel filler door opening device in the lockable retracted position in accordance with the present invention;

FIG. 13 is a top plan view of the fuel filler door and the fuel filler door opening device in the retracted position in accordance with the present invention;

FIG. 14 is a bottom plan view of the fuel filler door and the fuel filler door opening device in the retracted position in accordance with the present invention;

FIG. 15 is a side elevational view of the fuel filler door opening device in the retracted position in accordance with the present invention;

FIG. 16 is a top plan view of the fuel filler door and the fuel filler door opening device in the extended position such that the door is being opened by the fuel filler door opening device;

FIG. 17 is a bottom plan view of the fuel filler door and the fuel filler door opening device in the extended position such that the vehicle door is being opened by the fuel filler door opening device; and

FIG. 18 is a side elevational view of the fuel filler door opening device in the extended position in accordance with the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

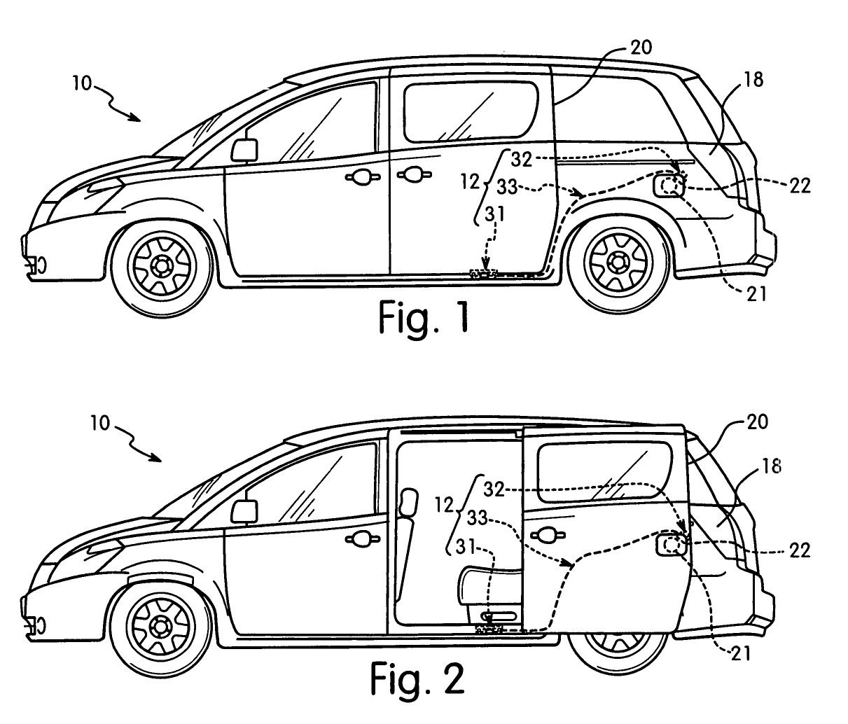

Referring initially to FIGS. 1-4, a vehicle 10 is illustrated that is equipped with a vehicle sliding interlock mechanism 12 in accordance with a first embodiment of the present invention. While the vehicle 10 is illustrated as a van, it would be apparent to those skilled in the art from this disclosure that the present invention can be utilized with other types of vehicles with sliding doors. Moreover, since the precise structure of the vehicle is not critical to the present invention, only those features of the vehicle 10 that relate to the present invention will be discussed and illustrated herein.

Basically, the vehicle 10 has a vehicle body 18 with a sliding rear door 20 and a fuel filler pipe or inlet 21 that are located on the same side of the vehicle 10. As seen in FIGS. 1 and 2, the sliding door 10 slides along the exterior side of the vehicle 10 from a retracted or closed position (FIG. 1) to an extended or opened position (FIG. 2). In the illustrated embodiment, the sliding rear door 20 and the fuel filler inlet 21 are located on the driver's side of the vehicle 10. While the present invention is illustrated with the sliding door 20 and the fuel filler inlet 21 on the driver's side of the vehicle 10, it would be apparent to those skilled in the art from this disclosure that the present invention can be utilized in a vehicle having a sliding door and a fuel filler inlet on the passenger's side of the vehicle.

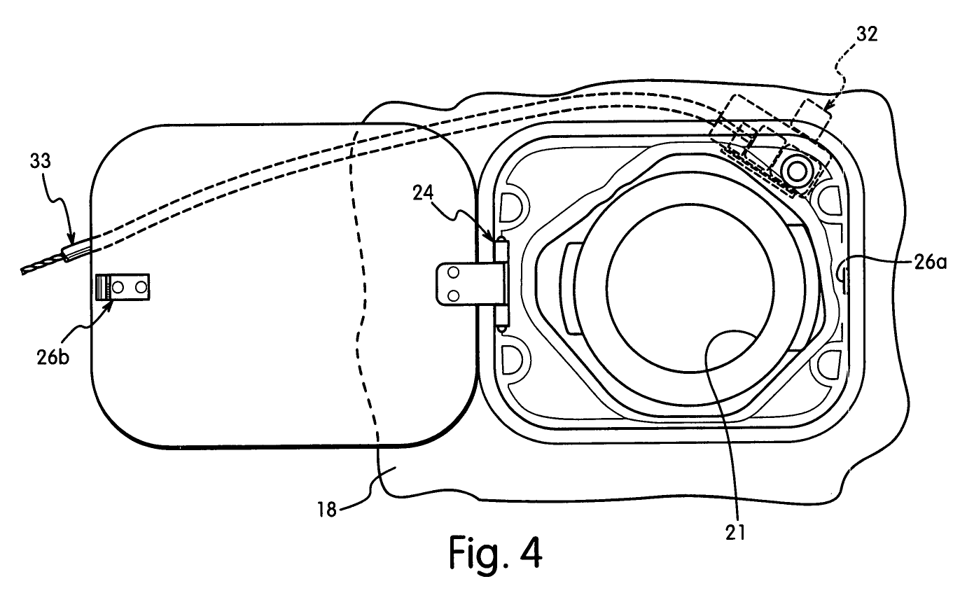

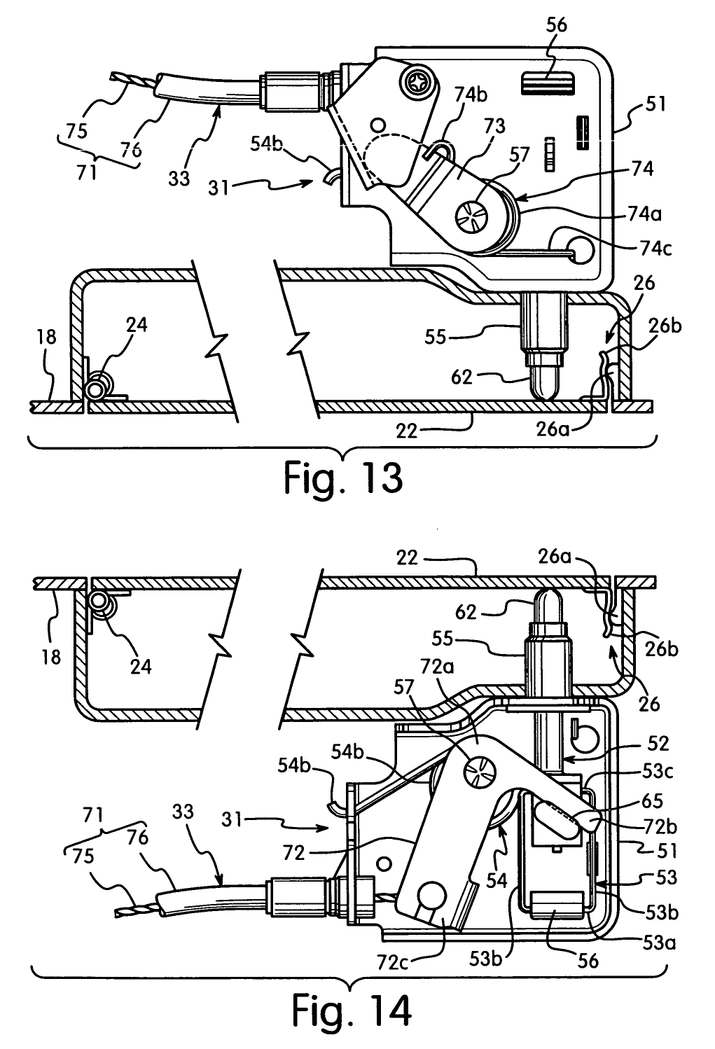

The fuel filler inlet 21 is covered by a fuel filler door 22 that is flushly mounted relative to the exterior surface of the vehicle body 18 of the vehicle 10. The fuel filler door 22 is pivotally coupled to the vehicle body 18 by a hinge 24. Normally, the fuel filler door 22, in the illustrated embodiment, is held closed by a latch mechanism 26 (see FIGS. 4, 13 and 14) that is coupled between the fuel filler door 22 and the vehicle body 18 of the vehicle 10. In particular, the latch mechanism 26 preferably includes a stationary latching member 26a and a resilient clip member 26b. The latch member 26a is fixedly mounted to the vehicle body 18 of the vehicle 10 adjacent the fuel filler inlet 21, while the clip member 26b is fixedly mounted to the fuel filler door 22 on the side opposite the hinge 24. When the fuel filler door 22 is pivoted from the opened position to the closed position, the resilient clip member 26b is deflected towards the hinge 26 upon engagement of the latch member 26a. Then further movement of the fuel filler door 22 results in opposing abutment surfaces of the latch member 26a and the clip member 26b contacting each other to retain the fuel filler door in the closed position (see FIGS. 13 and 14).

Referring back to FIG. 2, when the sliding door 20 is in the opened position as seen in FIG. 2, the sliding door 20 extends over the fuel filler door 22. Accordingly, if the fuel filler door 22 is opened and then the sliding door 20 is moved to the opened position, the sliding door 20 would then hit the fuel filler door 22. Thus, the vehicle sliding interlock mechanism 12 of the present invention locks the sliding door 20 in the closed position when the fuel filler door 22 is pivoted to its opened position.

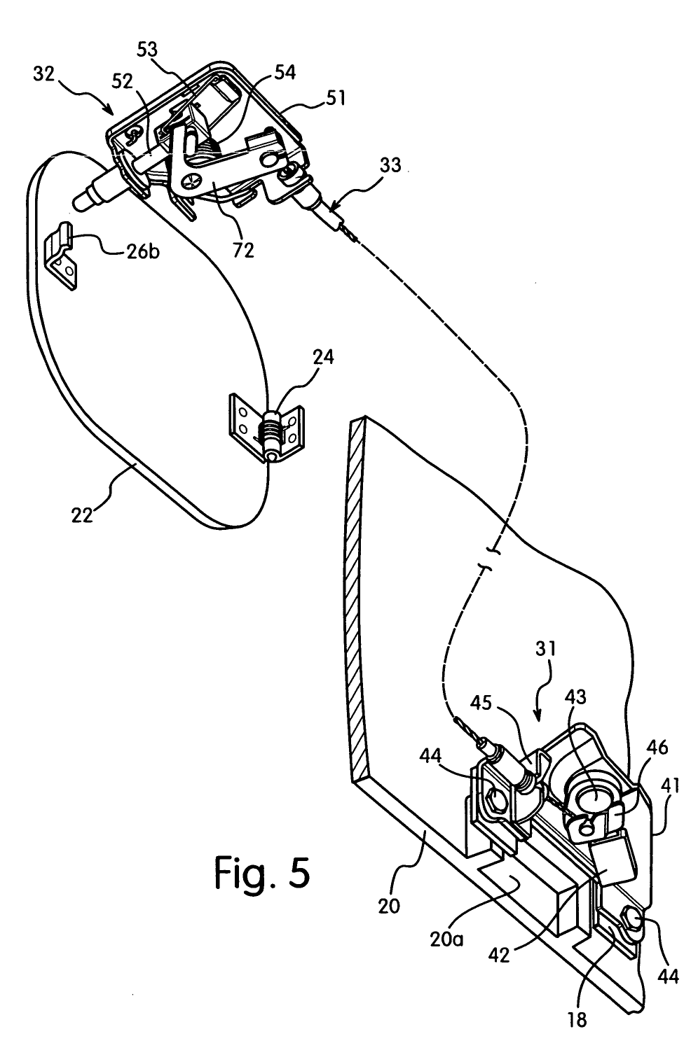

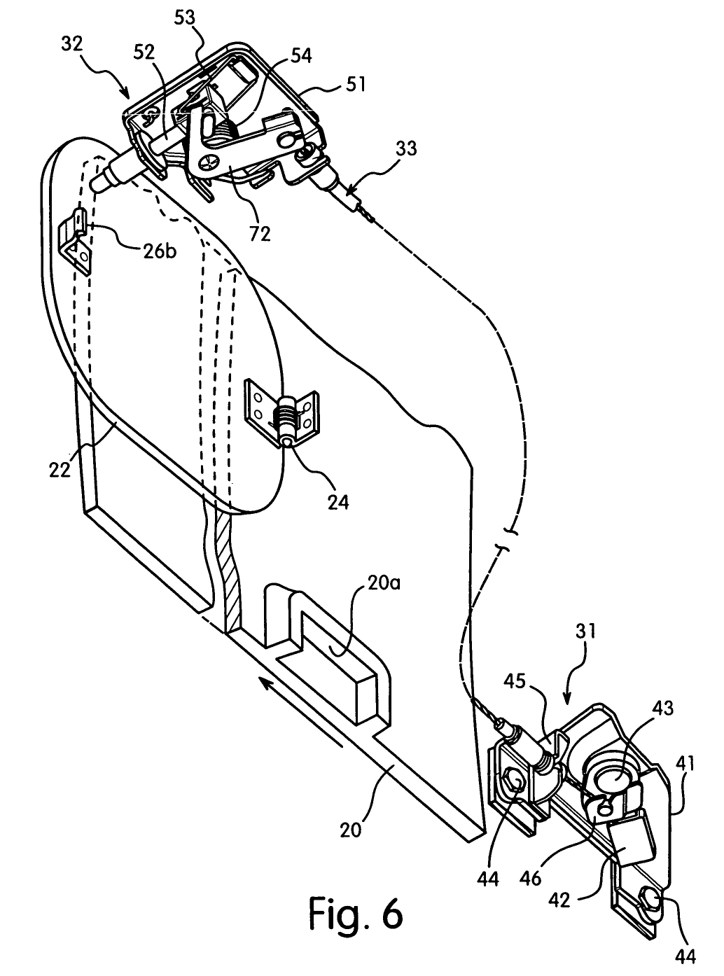

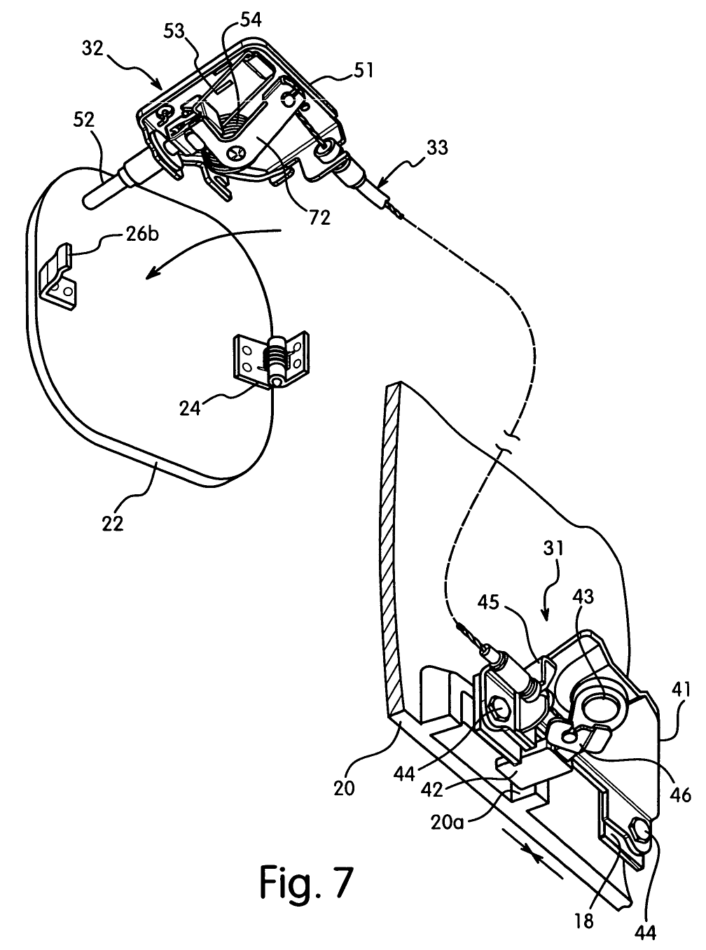

Referring now to FIGS. 5-7, the vehicle sliding door interlock mechanism 12 basically includes a sliding door locking device 31, a fuel filler door opening device 32 and a linkage arrangement 33 that operatively couples the sliding door locking device 31 and the fuel filler door opening device 32 together. As seen in FIGS. 5 and 6, when the fuel filler door 22 is closed, the fuel filler door opening device 32 is in a retracted position and the sliding door locking device 31 is in an unlocked position such that the sliding door 20 is free to slide as seen in FIGS. 1 and 2. As seen in FIG. 7, when the fuel filler door 22 is opened by the fuel filler door opening device 32, the fuel filler door opening device 32 is in an extended position which operates the sliding door locking device 31 to move to a locked position such that the sliding door 20 is prevented from being opened. In particular, when the fuel filler door 22 is pivoted to the opened position by an opening force from the fuel filler opening device 32, the linkage arrangement 33 will operate the sliding door locking device 31 to lock the sliding door 20 of the vehicle 10 such that the sliding door 20 cannot be moved to the opened position as seen in FIG. 2.

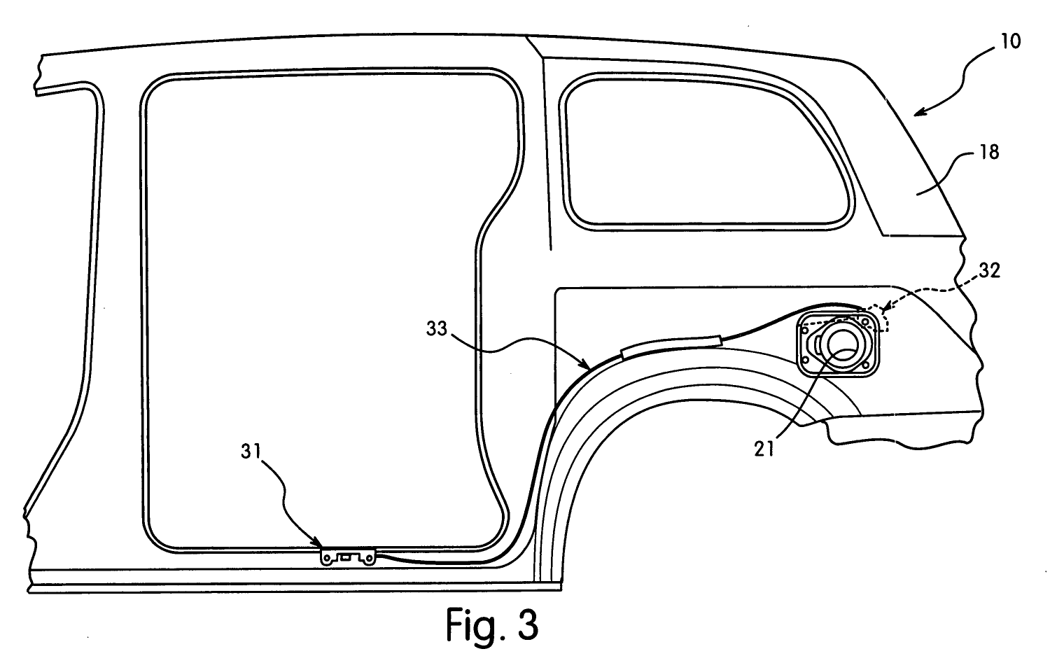

Now, the sliding door locking device 31 will be discussed in more detail with reference to FIGS. 2, 3 and 8-10. As seen in FIGS. 2 and 3, the sliding door locking device 31 is disposed in a sill area of the opening for the sliding door 20. However, it would be apparent to those skilled in the art from this disclosure that the sliding door locking device 31 can be located in other areas of vehicle 10 as needed and/or desired so long as the sliding door locking device 31 is configured to selectively lock the sliding door 20 when the fuel filler door 22 is in the opened position. Since the precise mounting of the sliding door locking device 31 to the vehicle body 18 is not important to the present invention, the mounting arrangement between the sliding door locking device 31 and the vehicle body 18 will only be somewhat diagrammatically illustrated.

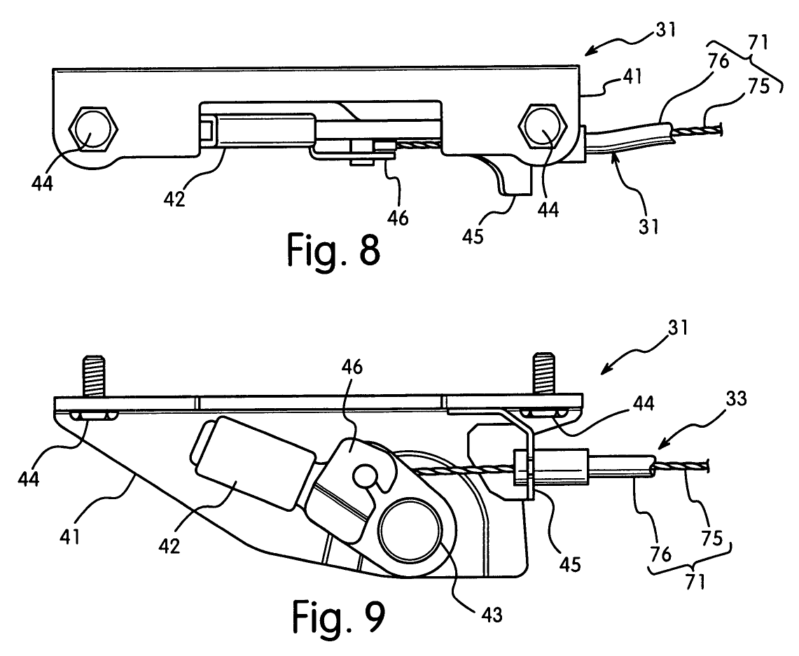

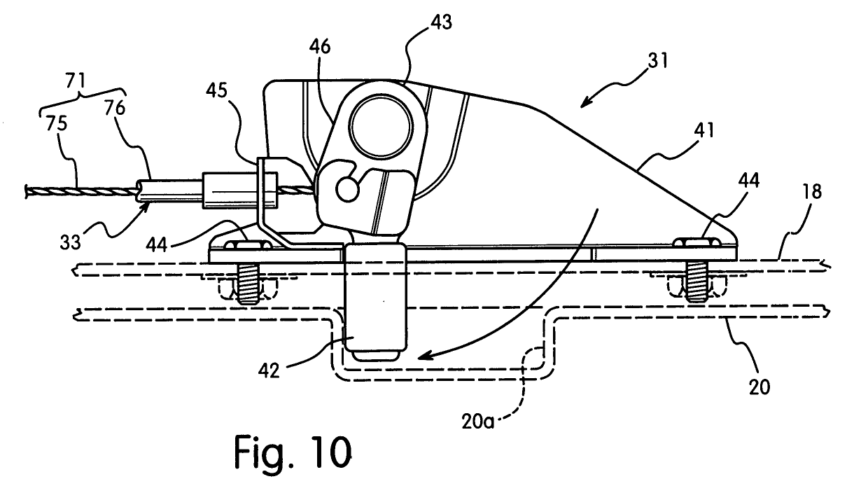

As seen in FIGS. 8 and 9, the sliding door locking device 31 preferably includes a mounting bracket 41 and a locking member 42 that is pivotally attached to the mounting bracket 41 via a pivot pin 43. The mounting member 41 is preferably attached to the vehicle body 18 via a pair of fasteners or bolts 44 in a conventional manner to the sill area of the opening for the sliding door 20. The sliding door locking device 31 is operated by the link arrangement 33 to move between the unlocked position shown in FIG. 9 and the locked position shown in FIG. 10.

The mounting bracket 41 is preferably constructed form a hard rigid material such as a metal material. The mounting bracket 41 includes a first cable attachment point 45 for attaching a portion of one end of the link arrangement 33 thereto.

The locking member 42 is pivotally arranged to move from a retracted (unlocked) position to an extended (locked) position in response to movement of the linkage arrangement 33 by the fuel filler door opening device 32 as explained below. In particular, the locking member 42 is provided with a cable attachment point 46 for attaching a portion of one end of the linkage arrangement 32 thereto. When the locking member 42 is pivoted to the locked position, the locking member 42 is disposed in a notch or recess 20a in the sliding door 20 as seen in FIGS. 7 and 10. Thus, the sliding door 20 is prevented from being opened when the locking member 42 is in the extended or locked position. When the locking member 42 is in the retracted or unlocked position, the sliding door 20 is free to slide between the close and opened positions as seen in FIGS. 5 and 6.

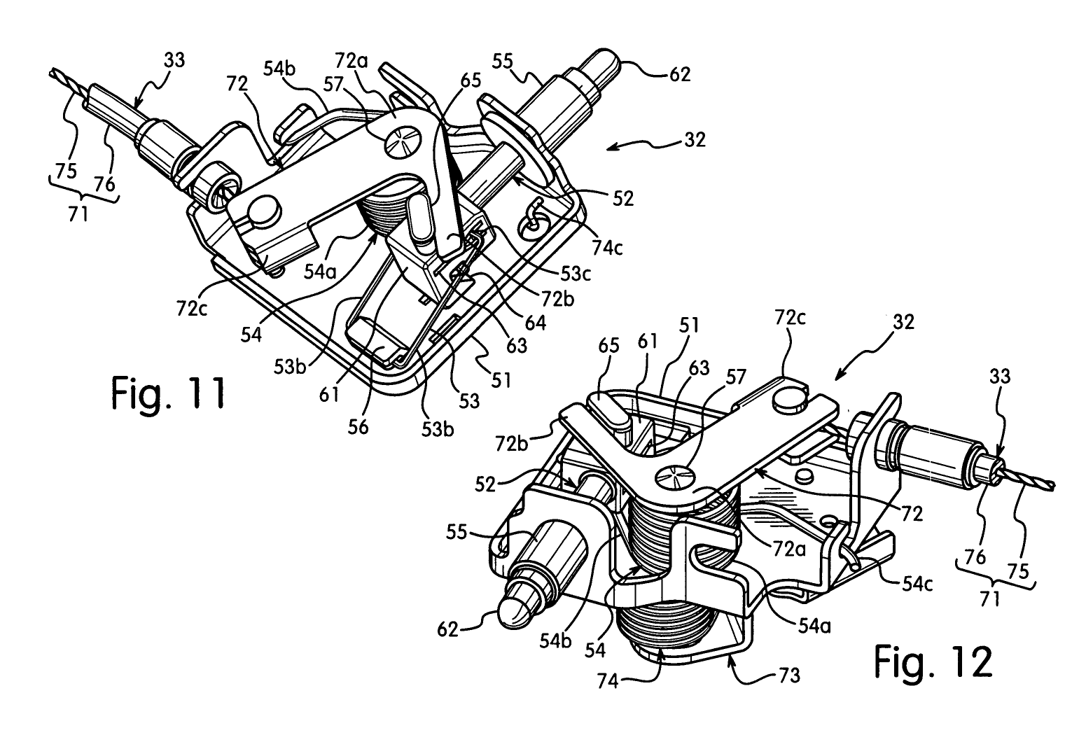

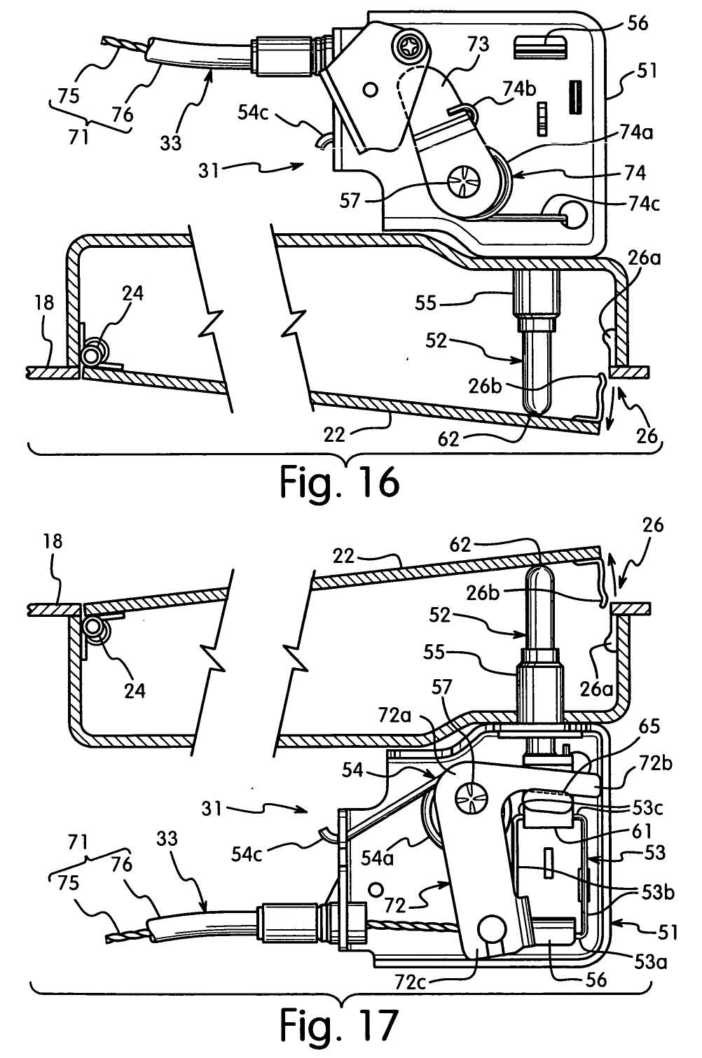

Returning now to the fuel filler opening device 32, as seen in FIG. 11-18, the fuel filler opening device 32 basically includes a base member 51, a plunger 52, a plunger retaining member 53 and a plunger biasing element 54. In the illustrated embodiment, the fuel filler opening device 32 is disposed adjacent the upper corner of the fuel filler door 22 that is opposite the hinge 24 of the fuel filler door 22. However, the precise location of the fuel filler door opening device 32 relative to the fuel filler door 22 is not important to the basic idea of the present invention. Rather, the fuel filler door opening device 32 can be located in different locations as needed and/or desired so long as the fuel filler door opening device 32 is configured and arranged to selectively apply a sufficient opening force to the fuel filler door 22 so that the fuel filler door 22 is opened. More particularly, the fuel filler opening device 32 is configured and arranged to apply an opening force that overrides the snap-fit type connection between the latch member 26a and the clip member 26b so that the fuel filler door 22 is pivoted to the opened position about the pivot axis of the hinge 24.

The base member 51 is preferably a hard rigid member that is fixedly coupled to the vehicle body 18 via fasteners (not shown) or the like. Preferably, the base member 51 is constructed of a sheet metal material that is bent to the desired configuration. The base member 51 slideably supports the plunger 52 for movement between a lockable retracted position and an extended position. Preferably, a gasket 55 is provided between the base member 51 and the plunger 52 to create a seal therebetween. Moreover, the plunger retaining member 53 is movably retained on the base member 51 by an attachment flange 56. The plunger biasing element 54 mounted on the base member 51 by a pivot pin 57.

Generally speaking, the plunger 52 is configured to selectively apply an opening force to the fuel filler door 22 during movement of the plunger from the lockable retracted position to the extended position. The plunger retaining member 53 is generally configured and arranged to lock the plunger 52 in the lockable retracted position when the plunger 52 is moved from the extended position to the lockable retracted position by the fuel filler door 22 being moved from its opened position to its closed position. The movement of the plunger 52 is generally controlled by the cooperation between the plunger 52 and the plunger retaining member 53. In particular, the plunger retaining member 53 is configured and arranged to release the plunger 52 when the plunger 52 is moved inwardly by the fuel filler door 22 from the lockable retracted position to a further retracted position. When the plunger 52 is in the further retracted position, the plunger position retracting member 53 releases the plunger 52 such that the plunger biasing element 52 applies an urging force to move the plunger 52 from the retracted position to the extended position. This movement of the plunger 52 from the retracted position to the extended position causes the plunger 52 to apply an opening force to the fuel filler door 22 that overrides the latching mechanism 26 such that the fuel filler door 22 is swung to the opened position.

Preferably, the plunger 52 is constructed of a one-piece unitary element such as a hard rigid plastic material or a light weight metal material. Basically, the plunger 51a an inner control end portion 61 and an outer fuel filler door engagement portion 62. The control end portion 61 is a block shaped section, while the outer fuel filler door engagement portion 62 is a rod shaped section. The control end portion 61 preferably has a pair of control grooves 63, a spring receiving notch 64 and a linkage engagement projection 65.

The control grooves 63 are located on opposite side faces with each of the control grooves 63 being engaged with the plunger retaining member 53 to selectively lock the plunger 52 in the retracted position. The control grooves 63 and the plunger retaining member 53 constitute a plunger position retaining arrangement that is operatively coupled to the plunger 52 to selectively retain the plunger 52 in one of the lockable retracted position and the extended position in response to axial movement of the plunger 52.

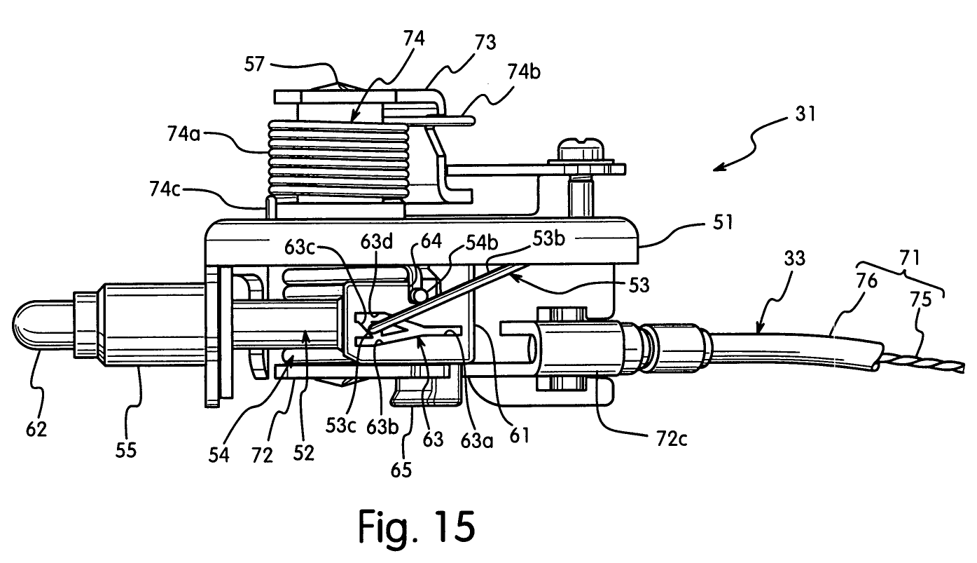

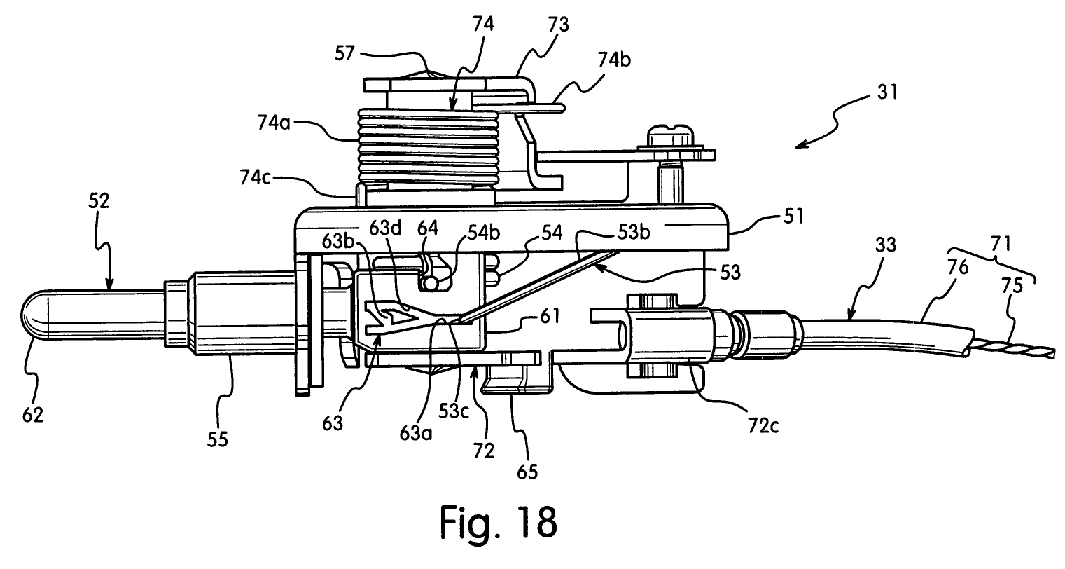

As seen in FIGS. 15 and 18, each of the control grooves 63 in the control portion 61 of the plunger 52 has a common track section 63a, a lower track section 63b, an upper track section 63c and a connecting track section 63d that includes a retaining position. When the plunger 52 is in the lockable retracted position, the plunger retaining member 53 is located in the retaining position of the connecting track section 63d of the control slot 63 as seen in FIG. 15. However, when the plunger 52 is pushed inwardly by the fuel filler door 22 to the further retracted position, the plunger retaining member 53 rides up the connecting track section 63d to an end position of the upper track section 63c. In this position the plunger 52 is now free to move to the extended position due to the urging force of the plunger biasing element 54. In other words, the plunger retaining member 53 rides along the upper track section 63c to the common track section 63a under the urging force of the plunger biasing element 54 such that the plunger 52 as fully extended as seen in FIG. 15. When the fuel filler door 22 is closed, the plunger 52 is pushed back into the base member 51 to the retracted position. This movement of the plunger 52 from the extended position to the retracted position results in the plunger retaining member 53 riding along the lower track section 63b and then up into the connecting track section 63d where the plunger retaining member 53 rests to lock the plunger 52 in the retracted position.

The spring receiving notch 64 is engaged with the plunger biasing element 54 such that the plunger biasing element 54 urges the plunger 52 from the retracted position to the extended position. However, movement of the plunger 52 is restricted by the plunger retaining member 53 engaging the control grooves 63 of the control end portion 61 of the plunger 52 as mentioned above.

The linkage engagement projection 65 is engaged by the linkage arrangement 33, as discussed below, such that linear movement of the plunger 52 between the lockable retracted position and the extended position is transmitted to the linkage arrangement 33. Accordingly, when the fuel filler door 22 is closed, the plunger 52 of the fuel filler door opening device 32 is in the retracted position such that the sliding door locking device 31 is maintained in the unlocked position such that the sliding door 20 is free to slide as seen in FIGS. 1 and 2. However, when the fuel filler door 22 is opened by the plunger 52 of the fuel filler door opening device 32, this linear movement of the plunger 52 from the retracted position to the extended position operates the sliding door locking device 31 to move to the locked position such that the sliding door 20 is prevented from being opened.

The plunger retaining member 53 is preferably a generally U-shaped wire member having a mounting portion 53a and a pair of arm portions 53b with inward turned free ends 53c. The mounting portion 53a of the plunger retaining member 53 is retained on the base member 51 by the attachment flange 56 of the base member 51 such that the inward turned free ends 53c are urged towards the base member 51. The inward turned free ends 53c are engaged with the control slots 63 such that the movement of the plunger 52 is controlled as mentioned above.

In the preferred embodiment, the biasing element 54 is preferably a metal torsion spring having a coiled portion 54a, a first end 54b and a second end 54c. The coiled portion 54a of the biasing element 54 is positioned on the pivot pin 57 that is rotatably mounted to the base member 51. The first end 54b of the biasing element 54 is engaged in the spring receiving notch 64 of the plunger 52. The second end 54c of the biasing element 54 is located in an opening of the base member 51. Accordingly, the biasing element 54 applies an urging force on the plunger 52 such that the plunger 52 is normally biased outwardly to the extended position as mentioned above. However, the plunger retaining member 53 is configured and arranged to hold the plunger 52 in the retracted position as mentioned above.

The linkage arrangement 33 basically includes a cable 71, a link member 72, a lever arm 73 and a biasing element 74. The cable 71 preferably includes an inner wire 75 and an outer casing 76. The first end of the inner wire 75 is coupled to the locking member 42 of the sliding door locking device 31 as seen in FIGS. 9 and 10, while the second end of the inner wire 75 is operatively coupled to the plunger 52 via the link member 72 that is pivotally mounted on the base member 51 as seen in FIGS. 11 and 12. The outer casing 76 is fixedly attached to the mounting member 41 of the sliding door locking device 31 as seen in FIGS. 9 and 10, while the second end of the outer casing 76 is coupled to the base member 51 of the fuel filler door opening device 33 as seen in FIGS. 11 and 12.

The link member 72 is preferably a generally L-shaped member having a central pivot portion 72a, a plunger engagement portion 72b and an inner wire attachment portion 72c. The pivot portion 72a of the link member 72 is pivotally attached to the base member 51 via the pivot pin 57. In particular, the link member 72 is attached to the opposite end of the pivot pin 57 from the lever arm 73 such that the link member 72 lies on one side of the base member 51 and the lever arm 73 lies on the opposite side of the base member 51.

The lever arm 73 is urged by the biasing element 74 such that the biasing element 74 applies an urging force to the linkage arrangement 33 to normally maintain the locking member 42 in its unlocked position. In other words, the lever arm 73 is urged by the biasing element 74 to rotate the link member 72 which in turn pushes the inner wire 75 within the outer casing 76 to pivot the locking member 42 about the pivot axis of the pivot pin 43 to its unlocked position. Thus, the biasing element 74 also urges the link member 72 to pivot about the pivot axis of the pivot pin 57 such that the plunger engagement portion 72b engages the linkage engagement projection 65 on the plunger 52. The biasing force of the plunger biasing element 54 is greater than the biasing force of the biasing element 74. Thus, when the plunger 52 moves to the extended position under the force of the plunger biasing element 54, the link member 72 is rotated against the biasing force of the biasing element 74. Since the inner wire attachment portion 72c is coupled to the second end of the inner wire 75, the inner wire 75 is pushed or pulled relative to the outer casing 76 in response to this pivotal movement of the link member 72 by the linear movement of the plunger 52.

In the preferred embodiment, the biasing element 74 is preferably a metal torsion spring having a coiled portion 74a, a first end 74b and a second end 74c. The coiled portion 74a of the biasing element 74 is positioned on the pivot pin 57 that is rotatably mounted to the base member 51. The first end 74b of the biasing element 74 is engaged in the lever arm 73. The second end 74c of the biasing element 74 is located in an opening of the base member 51. Accordingly, the biasing element 74 applies an urging force on the lever arm 73 such that the plunger engagement portion 72b of the lever arm 73 is normally biased against the linkage engagement projection 65 on the plunger 52 and the inner wire attachment portion 72c pushes the inner wire 75 to maintain the locking member 42 in its unlocked position.

Accordingly, the vehicle sliding interlock mechanism 12 that is relatively inexpensive to manufacture since the total number of parts needed for the vehicle sliding interlock mechanism 12 is reduced.

As used herein to describe the above embodiment, the following directional terms “forward, rearward, above, downward, vertical, horizontal, below and transverse” as well as any other similar directional terms refer to those directions of a vehicle equipped with the present invention. Accordingly, these terms, as utilized to describe the present invention should be interpreted relative to a vehicle equipped with the present invention. Moreover, terms that are expressed as “means-plus function” in the claims should include any structure that can be utilized to carry out the function of that part of the present invention. The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A vehicle sliding door interlock mechanism comprising:
a sliding door locking device configured to selectively lock a sliding door of a vehicle;
a fuel filler door opening device having a plunger that is selectively movable between a lockable retracted position and an extended position in which the plunger is configured to selectively apply an opening force to a fuel filler door when the plunger moves from the lockable retracted position to the extended position; and
a linkage arrangement operatively coupled between the sliding door locking device and the plunger of the fuel filler door opening device to selectively operate the sliding door locking device to lock the sliding door of the vehicle in response to the plunger moving from the lockable retracted position to the extended position.

2. The vehicle sliding door interlock mechanism according to claim 1, further comprising
a first biasing element arranged to apply a biasing force on the plunger to urge the plunger to the extended position to open the fuel filler door.

3. The vehicle sliding door interlock mechanism according to claim 2, wherein
the first biasing element is further arranged to apply a biasing force on the linkage arrangement to urge the linkage arrangement to operate the sliding door locking device to lock the sliding door of the vehicle.

4. The vehicle sliding door interlock mechanism according to claim 3, further comprising
a second biasing element arranged to apply a biasing force on the linkage arrangement to operate the sliding door locking device to unlock the sliding door of the vehicle.

5. The vehicle sliding door interlock mechanism according to claim 4, wherein
the second biasing element is a torsion spring.

6. The vehicle sliding door interlock mechanism according to claim 5, wherein
the first biasing element is a torsion spring.

7. The vehicle sliding door interlock mechanism according to claim 3, wherein
the first biasing element is a torsion spring.

8. The vehicle sliding door interlock mechanism according to claim 4, further comprising
a base member supporting the plunger for slidable movement between the lockable retracted position and the extended position with the first and second biasing elements mounted to the base member.

9. The vehicle sliding door interlock mechanism according to claim 8, wherein
the linkage arrangement includes a link member pivotally mounted on the base member with a first end of the link member operatively engaged with the plunger.

10. The vehicle sliding door interlock mechanism according to claim 9, wherein the link member is pivotally mounted to the base member by a pivot pin with the first and second biasing elements being supported on the base member by the pivot pin.

11. The vehicle sliding door interlock mechanism according to claim 10, wherein
the first and second biasing elements are first and second torsion springs, respectively, with coiled portion disposed on the pivot pin.

12. The vehicle sliding door interlock mechanism according to claim 11, wherein
the first torsion spring has a first end operatively engaging the base member and a second end operatively urging the plunger to the extended position; and
the second torsion spring has a first end operatively engaging the base member and a second end operatively urging the link member to operate the sliding door locking device to unlock the sliding door of the vehicle.

13. The vehicle sliding door interlock mechanism according to claim 4, further comprising
a plunger position retaining arrangement operatively coupled to the plunger to selectively retain the plunger in one of the lockable retracted position and the extended position in response to axial movement of the plunger.

14. The vehicle sliding door interlock mechanism according to claim 1, wherein
the linkage arrangement includes a cable having a first end coupled to the sliding door locking device and a second end operatively coupled to the plunger.

15. The vehicle sliding door interlock mechanism according to claim 14, wherein
the linkage arrangement further includes a pivotally mounted link member with a first end of the link member operatively engaged with the plunger and a second end coupled to the second end of the cable.

16. The vehicle sliding door interlock mechanism according to claim 15, further comprising
a first biasing element arranged to apply a biasing force on the plunger to urge the plunger to the extended position to open the fuel filler door.

17. The vehicle sliding door interlock mechanism according to claim 16, further comprising
a second biasing element biases the first end of the link member against the plunger to apply a biasing force on the plunger towards the lockable retracted position.

18. The vehicle sliding door interlock mechanism according to claim 17, wherein
the first end of the link member and the plunger are non-fixedly connected such that the plunger is independently movable relative to the link member from the extended position to the lockable retracted position when the sliding door locking device is locking the sliding door.

19. The vehicle sliding door interlock mechanism according to claim 17, wherein
the linkage arrangement further includes a lever arm fixed to a pivot pin with the link member being fixed on the pivot pin and the second biasing element engaging the lever arm to urge the first end of the link member against the plunger.

20. The vehicle sliding door interlock mechanism according to claim 1, further comprising
a plunger position retaining arrangement operatively coupled to the plunger to selectively retain the plunger in one of the lockable retracted position and the extended position in response to axial movement of the plunger.

21. The vehicle sliding door interlock mechanism according to claim 1, wherein
the linkage arrangement includes a cable having a first end coupled to the sliding door locking device and a second end operatively coupled to the plunger.
